(19) United States
(12) Patent Application Publication
(10) Pub. No.: US 2013/0222317 A1
(43) Pub. Date: Aug. 29, 2013

(54) DISPLAY DEVICE, AND PROCESS FOR MANUFACTURING DISPLAY DEVICE

(71) Applicants: Manabu Abiru, Osaka-shi (JP); Kazutoshi Kida, Osaka-shi (JP); Shinji Yamagishi, Osaka-shi (JP)

(72) Inventors: Manabu Abiru, Osaka-shi (JP); Kazutoshi Kida, Osaka-shi (JP); Shinji Yamagishi, Osaka-shi (JP)

(73) Assignee: SHARP KABUSHIKI KAISHA, Osaka-shi, Osaka (JP)

(21) Appl. No.: 13/877,671

(22) PCT Filed: Oct. 3, 2011
(86) PCT No.: PCT/JP2011/072800

§ 371 Date: Apr. 4, 2013

(30) Foreign Application Priority Data
Oct. 8, 2010 (JP) 2010-228772

(51) Int. Cl. G06F 3/041

(52) U.S. Cl. CPC G06F 3/0412
USPC 345/173; 29/846

(57) ABSTRACT

An X electrode (18) is provided on a surface of a phase plate (15) which surface faces a liquid crystal panel (10). A Y electrode (19) is provided on a surface of a polarizing plate (17) which surface faces the liquid crystal panel (10). This makes it possible to provide a display device that has a touch function and can reduce a thickness and improve display quality.

### TECHNICAL FIELD

The present invention relates to a display device and a method for manufacturing a display device. In particular, the present invention relates to a display device having a touch function and a method for manufacturing such a display device.

### BACKGROUND ART

In display devices, touch panels are often provided so that a user can easily operate the display device while viewing its screen.

There have already been various types of touch panels in practical use. In recent years, capacitive touch panels are becoming popular. According to a capacitive touch panel, when a fingertip (which can be considered as an electric conductor) makes contact with a touch input surface, a capacitor is formed by a capacitive coupling of the fingertip and a conductive film. In the capacitive touch panel having such a configuration, coordinates of a contact location of the fingertip are detected by sensing a change in electric charge at the contact location.

In particular, a projective capacitive touch panel can detect a plurality of fingertips (multipoint detection), and therefore has good operationality that enables a user to give complex instructions. Because of the good operationality, the projective capacitive touch panels have come to be provided in apparatuses such as a mobile phone and a portable music player, each of which has a small display device. Specifically, the projective capacitive touch panel is used as an input device on a display surface of such a small display device.

Such a projective capacitive type can be further classified into a self-capacitance detection type and a mutual-capacitance detection type.

In a touch panel of the self-capacitance detection type, a plurality of X electrodes and a plurality of Y electrodes, which perpendicularly intersect with the X electrodes, are provided so as to form a two-layer structure, in order that two-dimensional coordinates can be expressed with an X-axis and a Y-axis. In a case where a fingertip touches such a touch panel, for example, an X-axis coordinate is detected based on a capacitive coupling of the fingertip and an X electrode, and a Y-axis coordinate is substantially simultaneously detected based on a capacitive coupling of the fingertip and a Y electrode.

The mutual-capacitance detection type can advantageously achieve a multipoint detection. A touch panel of the mutual-capacitance detection type detects a state where capacitance is changed by a contact of a finger at any of intersections of X electrodes and Y electrodes.

The following description will discuss a configuration of a conventional projective capacitive touch panel, with reference to FIG. 7.

FIG. 7 is a cross sectional view illustrating a configuration of a conventional projective capacitive touch panel.

A touch panel 110 of the projective capacitive type is stacked on a display device 120 via an air layer or via a resin layer (see FIG. 7).

In the touch panel 110, an X electrode 113 is provided on a surface of a base material 111 and a Y electrode 116 is provided on a surface of the base material 114 so as to form a two-layer structure. Further, a cover glass 117 is provided in the touch panel 110 for improving rigidity of the touch panel 110 and for protecting the touch panel 110. Note that the base material 111 and the base material 114 are adhered to each other via an adhesion layer 112, and the base material 114 and the cover glass 117 are adhered to each other via an adhesion layer 115.

According to the touch panel 110 having such a configuration, in a case where a fingertip (electric conductor) makes contact with an upper surface of the cover glass 117 which is a touch input surface, an X-axis coordinate is detected based on a capacitive coupling of the fingertip and the X electrode 113, and a Y-axis coordinate is substantially simultaneously detected based on a capacitive coupling of the fingertip and the Y electrode 116.

The display device 120 includes a display panel 121. A phase plate 123 and a polarizing plate 125 are stacked on one surface of the display panel 121, which one surface faces the touch panel 110. Further, a phase plate 122 and a polarizing plate 124 are stacked on the other surface of the display panel 121. Note that the display panel 121 is made up of a TFT substrate (not illustrated) and a counter substrate (not illustrated) which are joined together by a sealant, and a display element (e.g., a liquid-crystal element) is sealed in a space demarcated by the sealant.

According to such a conventional configuration, however, the touch panel 110 is stacked on the display device 120, and a volume of the entire display device 120 therefore becomes larger. This causes problems of deterioration in portability and in visibility.

In order to solve the problems, a technique for reducing a thickness of a display device has been proposed.

The following description will discuss a configuration of a projective capacitive touch panel disclosed in Patent Literature 1, with reference to FIG. 8.

FIG. 8 is a cross sectional view illustrating a configuration of the projective capacitive touch panel disclosed in Patent Literature 1.

As illustrated in FIG. 8, a touch panel 210 of the projective capacitive type is stacked on a liquid crystal display panel 220.

In the touch panel 210, X electrodes 212 are provided in a first layer on the base material 211, and Y electrodes 214 are provided in a second layer located above the first layer. The X electrodes 212 and the Y electrodes 214 are arranged so as not to overlap each other when viewed from above. A phase difference compensation layer 213 is provided between the X electrodes 212 and the Y electrodes 214 so as to cover the X electrodes 212. The phase difference compensation layer 213 is made up of a liquid crystal layer, which is in a mode identical with that of a liquid crystal layer of the liquid crystal display panel 220, so as to compensate a birefringent phase difference of the liquid crystal layer of the liquid crystal display panel 220.

By thus providing the phase difference compensation layer 213, which compensates an optical property of the liquid crystal display panel 220, i.e., a birefringent phase difference of the liquid crystal layer of the liquid crystal display panel 220, on the base material 211 of the touch panel 210, it is not necessary to additionally provide another phase plate. This makes it possible to reduce a thickness of the entire display device.

### CITATION LIST

### Patent Literature

### Patent Literature 1

Japanese Patent Application Publication Tokukai No. 2010-164938 A (Publication date: Jul. 29, 2010)

### SUMMARY OF INVENTION

### Technical Problem

However, according to the technique disclosed in Patent Literature 1, the optical property of the liquid crystal display panel is compensated by a liquid crystal material. Such a configuration causes problems that (i) an irregular color is caused by a level (height) difference between the X electrode and the Y electrode and (ii) uneven orientation is caused by an electric field.

The present invention is accomplished in view of the problems, and its object is to provide a display device having a touch function and a method for manufacturing such a display device, which can achieve a reduction in thickness of the display device and improve display quality.

### Solution to Problem

In order to attain the object, a display device of the present invention includes: a plurality of input detection electrodes, which are provided in a display area, for detecting an input on a display surface; a display panel; and a plurality of optical plate members that are stacked on the display panel and contribute to a display or to improvement in display quality, at least one of the plurality of input detection electrodes being provided on at least one of the plurality of optical plate members.

In order to attain the object, a method of the present invention for manufacturing a display device is a method for manufacturing a display device including a plurality of input detection electrodes, which are provided in a display area, for detecting an input on a display surface, the method including the steps of: providing at least one of the plurality of input detection electrodes on an optical plate member that contributes to a display or to improvement in display quality; and stacking the optical plate member, on which the at least one of the plurality of input detection electrodes has been provided, on a display panel.

According to the conventional configuration as above described with reference to FIG. 7, the input detection electrodes for detecting an input on the display surface are provided on a base material which is provided separately from the display device.

On the other hand, according to the configuration of the present invention, at least one of the plurality of input detection electrodes is provided on at least one of the plurality of optical plate members that contribute to a display or to improvement in display quality. In other words, the input detection electrode is provided on a member that is required in view of a display function.

According to the configuration of the present invention, it is therefore possible to omit a superfluous base material. Consequently, it is possible to reduce a thickness of the display device.

According to the configuration of the present invention, at least one of the plurality of input detection electrodes is provided on at least one of the plurality of optical plate members. From this, the configuration of the present invention is fundamentally different from the conventional configuration illustrated in FIG. 8 in which the input detection electrodes are provided on both sides of the liquid crystal layer. Therefore, in the configuration of the present invention, it is possible to prevent (i) an irregular color caused due to level (height) difference between electrodes and (ii) uneven orientation caused due to an electric field.

As such, the configuration of the present invention brings about an effect of improving display quality while reducing the thickness of the display device.

Note that the term “plate member” encompasses a wafer-thin member that is generally called a sheet or a film.

### Advantageous Effects of Invention

The display device of the present invention includes: a plurality of input detection electrodes, which are provided in a display area, for detecting an input on a display surface; a display panel; and a plurality of optical plate members that are stacked on the display panel and contribute to a display or to improvement in display quality, at least one of the plurality of input detection electrodes being provided on at least one of the plurality of optical plate members.

The method of the present invention for manufacturing a display device is a method for manufacturing a display device including a plurality of input detection electrodes, which are provided in a display area, for detecting an input on a display surface, the method including the steps of: providing at least one of the plurality of input detection electrodes on an optical plate member that contributes to a display or to improvement in display quality; and stacking the optical plate member, on which the at least one of the plurality of input detection electrodes has been provided, on a display panel.

Therefore, the display device brings about effects of reducing a thickness and of improving display quality.

### BRIEF DESCRIPTION OF DRAWINGS

FIG. 1

FIG. 1 is a cross sectional view illustrating a configuration of a liquid crystal display device in accordance with Embodiment 1.

FIG. 2

FIG. 2 is a plane view illustrating how X electrodes and Y electrodes are arranged in the liquid crystal display device in accordance with Embodiment 1.

FIG. 3

FIG. 3 is a cross sectional view illustrating a configuration of a liquid crystal display device in accordance with Modified Example 1.

FIG. 4

FIG. 4 is a cross sectional view illustrating a configuration of an organic EL display device in accordance with Embodiment 2.

FIG. 5

FIG. 5 is a plane view illustrating how X electrodes and Y electrodes are arranged in the organic EL display device in accordance with Embodiment 2.

FIG. 6

FIG. 6 is a cross sectional view illustrating a configuration of an organic EL display device in accordance with Modified Example 2.

FIG. 7

FIG. 7 is a cross sectional view illustrating a configuration of a conventional projective capacitive touch panel.

FIG. 8

FIG. 8 is a cross sectional view illustrating a configuration of a projective capacitive touch panel disclosed in Patent Literature 1.

FIG. 9

FIG. 9 is a cross sectional view illustrating a configuration of a liquid crystal panel provided in the liquid crystal display device in accordance with Embodiment 1.

FIG. 10

FIG. 10 is a cross sectional view illustrating a configuration of an organic EL panel provided in the organic EL display device in accordance with Embodiment 2.

### DESCRIPTION OF EMBODIMENTS

### Embodiment 1

The following description will discuss a display device in accordance with an embodiment of the present invention, with reference to FIGS. 1, 2, and 9. Note that, in Embodiment 1, an example is described in which a liquid crystal display device is employed as the display device.

FIG. 1 is a cross sectional view illustrating a configuration of the liquid crystal display device in accordance with Embodiment 1.

In a liquid crystal display device 1, a touch panel and a display device are integrated (see FIG. 1), unlike a conventional configuration in which a touch panel is stacked on a display device.

Specifically, the liquid crystal display device 1 includes a liquid crystal panel 10 which is made up of a TFT substrate (not illustrated in FIG. 1) and a counter substrate (not illustrated in FIG. 1) which are joined together by a sealant, and a liquid crystal layer (not illustrated in FIG. 1) is sealed in a space demarcated by the sealant.

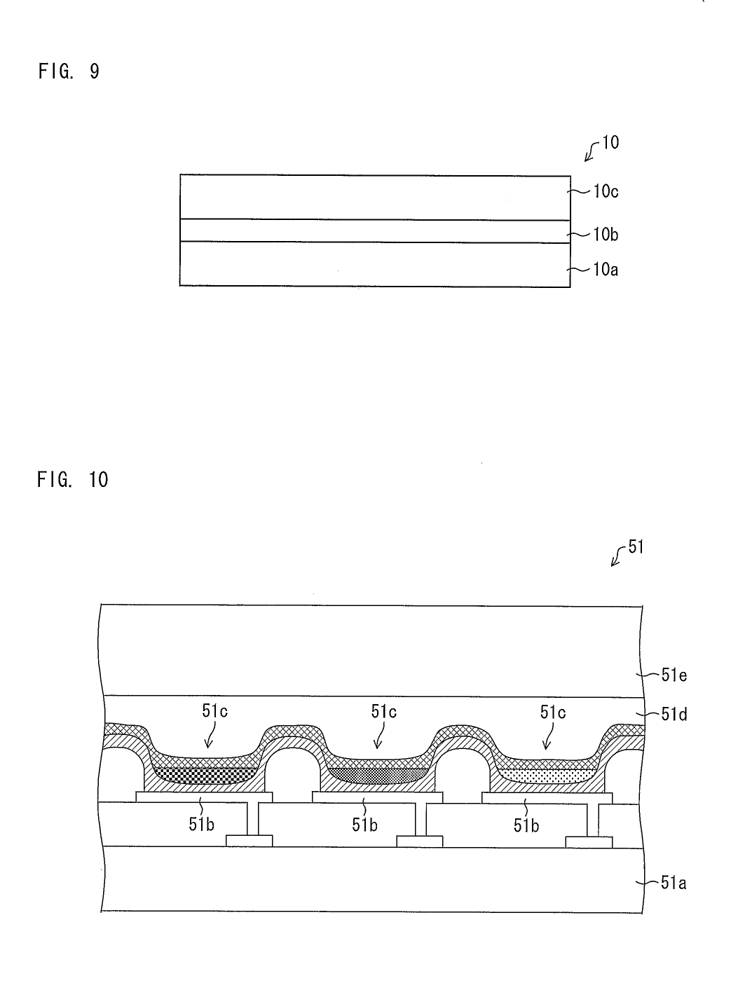

The following description will discuss a configuration of the liquid crystal panel 10 with reference to FIG. 9. FIG. 9 is a cross sectional view illustrating a configuration of the liquid crystal panel 10 provided in the display device of the present invention.

The liquid crystal panel 10 includes (i) a TFT substrate 10a which is an active matrix substrate, (ii) a liquid crystal layer 10b, and (iii) a counter substrate 10c which faces the TFT substrate 10a via the liquid crystal layer 10b (see FIG. 9).

Although not illustrated, the TFT substrate 10a has a configuration in which components such as a TFT element (not illustrated), which serves as a switching element, and a pixel electrode are provided on a glass substrate for each pixel. Moreover, although not illustrated, the counter substrate 10c has a configuration in which color filters and a common electrode are provided on a glass substrate. The TFT substrate 10a and the counter substrate 10c are provided so that the pixel electrodes face the common electrode via the liquid crystal layer 10b.

Outer surfaces (which are opposite to facing surfaces, i.e., both faces of the liquid crystal panel 10) of respective of the TFT substrate 10a and the counter substrate 10c are glass surfaces.

A phase plate 12 and a polarizing plate 13 are attached in this order to a lower surface of the liquid crystal panel 10 via an adhesive layer 11 (see FIG. 1). In this case, it is assumed that a touch input side of the liquid crystal panel 10 is an upper side, and a side opposite to the touch input side (upper side) is lower side.

Meanwhile, a phase plate 15 is attached to an upper surface of the liquid crystal panel 10 via an adhesive layer 14.

An X electrode 18 is provided on one surface of the phase plate 15 which one surface faces the liquid crystal panel 10. A polarizing plate 17 is attached to the other surface of the phase plate 15 via an adhesive layer 16.

A Y electrode 19 is provided on one surface of the polarizing plate 17 which one surface faces the phase plate 15.

That is, the X electrode 18 and the Y electrode 19 are provided on the phase plate 15 and the polarizing plate 17, respectively, so that a touched location will be detected as two-dimensional coordinates with an X-axis and a Y-axis.

According to the configuration, it is not necessary to additionally provide a base material in the liquid crystal display device 1 for providing the X electrode 18 and the Y electrode 19. This makes it possible to reduce a thickness of the entire liquid crystal display device 1 and to improve visibility.

The X electrode 18 and the Y electrode 19 may be provided on only one of the phase plate 15 and the polarizing plate 17.

That is, it is possible to employ a configuration in which (i) one of the X electrode 18 and the Y electrode 19 is provided on the one surface of the phase plate 15 and (ii) the other of the X electrode 18 and the Y electrode 19 is provided on the other surface of the phase plate 15.

Alternatively, it is possible to employ a configuration in which (i) one of the X electrode 18 and the Y electrode 19 is provided on the one surface of the polarizing plate 17 and (ii) the other of the X electrode 18 and the Y electrode 19 is provided on the other surface of the polarizing plate 17.

Each of the phase plate 15 and the polarizing plate 17 can be made of a generally used material.

It is preferable that the X electrode 18 and the Y electrode 19 (i) are made of a material such as transparent conductive ink which has been prepared by dispersing silver particles (nanowires) in a solution and (ii) are formed on the phase plate 15 and the polarizing plate 17, respectively, by a printing process that can be carried out at a low temperature.

According to the configuration, a transparent conductive material is used as the material of the X electrode 18 and the Y electrode 19. This prevents an adverse effect on visibility.

Moreover, according to the configuration, the X electrode 18 and the Y electrode 19 are formed on the phase plate 15 and the polarizing plate 17, respectively, by the printing process that can be carried out at a low temperature. This prevents adverse effects on the phase plate 15 and the polarizing plate 17 which are easily affected by heat.

Note that examples of the printing process encompass screen printing, ink-jet printing, and offset printing. Other than the ink in which silver particles (nanowires) are dispersed, a carbon nanotube (CNT) dispersed liquid having high transmittance can be used as a transparent electrode material, of which the X electrode 18 and the Y electrode 19 are made.

It is preferable to use a transparent adhesive agent as a material of the adhesive layers 11, 14, and 16. According to the configuration, visibility is not adversely affected.

In the liquid crystal display device 1, a cover glass 20 is provided so as to improve rigidity of the liquid crystal display device 1 and to protect the liquid crystal display device 1. The cover glass 20 can be made of a material such as a transparent glass or plastic.

The liquid crystal display device 1 of Embodiment 1 includes the cover glass 20. Note, however, that Embodiment 1 is not limited to this, and the cover glass 20 may be provided as appropriate.

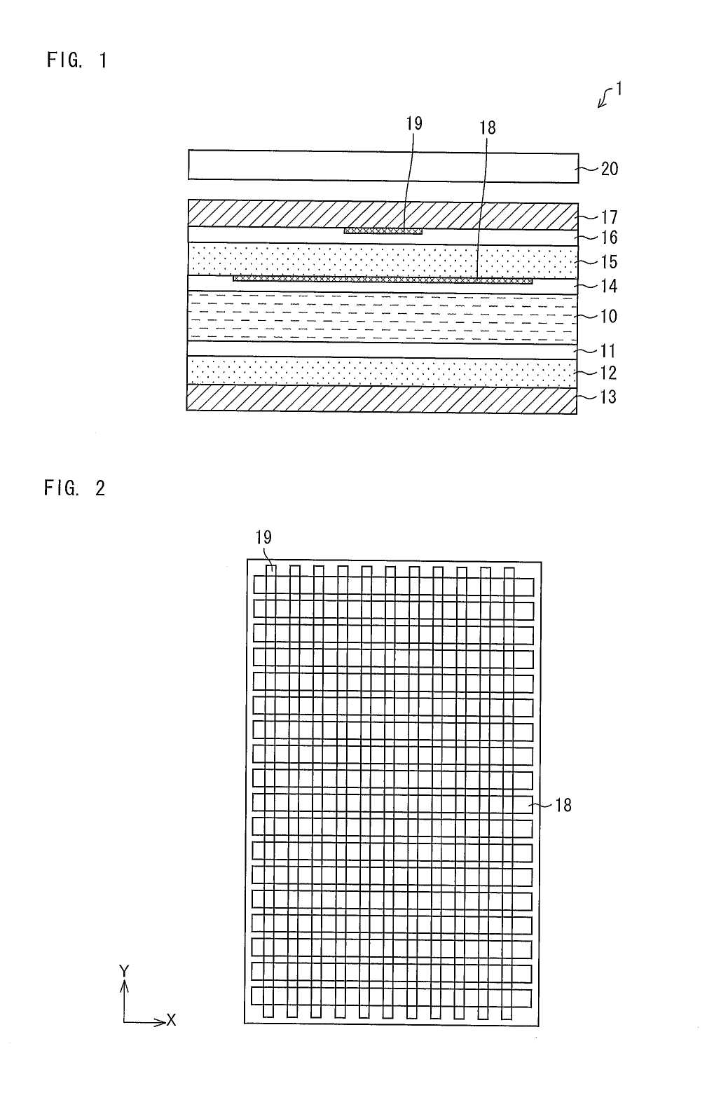

The following description will discuss how the X electrodes 18 and the Y electrodes 19 are arranged, with reference to FIG. 2.

FIG. 2 is a plane view illustrating how the X electrodes and the Y electrodes are arranged in the liquid crystal display device in accordance with Embodiment 1.

As illustrated in FIG. 2, a plurality of X electrodes 18, each of which has a belt-like shape, are arranged in parallel with each other, and a plurality of Y electrodes 19, each of which has a belt-like shape, are arranged in parallel with each other so as to perpendicularly intersect with the plurality of X electrodes 18, in order to express two-dimensional coordinates with the X-axis and the Y-axis.

That is, the plurality of X electrodes 18 extend in one direction and are arranged in parallel with each other. Meanwhile, the plurality of Y electrodes 19 (i) extend in a direction perpendicular to the one direction in which the plurality of X electrodes extend and (ii) are arranged in parallel with each other.

In a case where a fingertip (electric conductor) makes contact with a touch input surface, capacitance at intersections of the X electrodes 18 and the Y electrodes 19 is changed. This allows the liquid crystal display device 1 to detect two-dimensional coordinates of a location touched by the fingertip.

Note that the X electrode 18 is wider than the Y electrode 19 (see FIG. 2). This is because of the following reason: In a mutual-capacitance detection type, two-dimensional coordinates of a location touched by a fingertip (electric conductor) are detected by measuring change in capacitance at intersections of the X electrodes 18 and the Y electrodes 19 when the fingertip makes contact with the touch input surface. Under the circumstances, a width of a lower electrode (X electrode 18) is enlarged so that (i) electric flux lines, which indicate an electric field directed from the lower electrode (X electrode 18) to an upper electrode (Y electrode 19), reach above the upper electrode (Y electrode 19) and therefore (ii) the electric field would be changed by a finger.

In Embodiment 1, the X electrode 18 is provided on the one surface of the phase plate 15 which one surface faces the liquid crystal panel 10, and the Y electrode 19 is provided on the one surface of the polarizing plate 17 which one surface faces the liquid crystal panel 10. Note, however, that Embodiment 1 is not limited to this, and the X electrode 18 and the Y electrode 19 can be provided as appropriate on the phase plate or the polarizing plate so that the X electrode 18 and the Y electrode 19 are located in different layers. The following description will discuss Modified Example 1 in which locations of the X electrode 18 and the Y electrode 19 are different from those of Embodiment 1.

### Modified Example 1

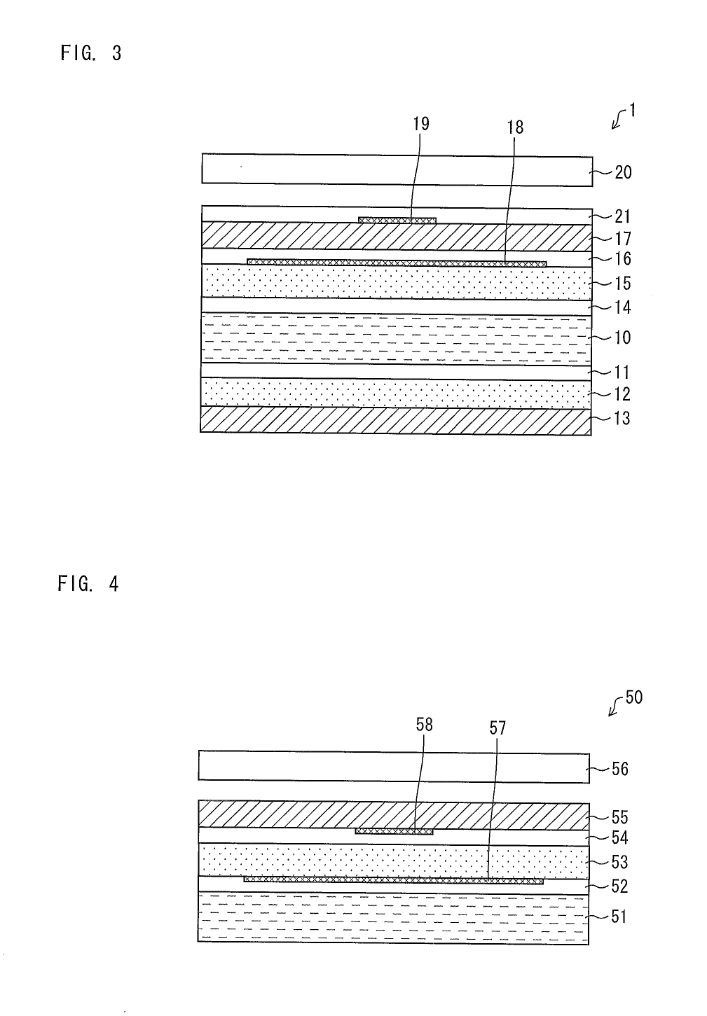

The following description will discuss a modified example of the liquid crystal display device of Embodiment 1, with reference to FIG. 3. FIG. 3 is a cross sectional view illustrating a configuration of a liquid crystal display device in accordance with Modified Example 1.

Note that, for convenience, the same reference numerals are given to constituent members which have functions identical with those of constituent members described in Embodiment 1.

In Modified Example 1, locations of the X electrode 18 and the Y electrode 19 are different from those in Embodiment 1.

Specifically, in Modified Example 1, the X electrode 18 is provided on a surface of the phase plate 15 which surface faces the polarizing plate 17, and the Y electrode 19 is provided on a surface of the polarizing plate 17 which surface faces the cover glass 20, unlike Embodiment 1 in which the X electrode 18 is provided on a surface of the phase plate 15 which surface faces the liquid crystal panel 10, and the Y electrode 19 is provided on a surface of the polarizing plate 17 which surface faces the liquid crystal panel 10. Note that an adhesive layer 21 is provided so as to cover the polarizing plate 17 and the Y electrode 19.

According to the configuration, it is not necessary to additionally provide a base material in the liquid crystal display device 1 for providing the X electrode 18 and the Y electrode 19, as with Embodiment 1. This makes it possible to reduce a thickness of the entire liquid crystal display device 1 and to improve visibility.

As such, in the liquid crystal display device 1, the phase plate 15 or the polarizing plate 17 is provided between the X electrodes 18 and the Y electrodes 19 which intersect with the X electrodes 18. This allows the X electrodes 18 and the Y electrodes 19 to serve as electrodes for detecting a touched location.

Moreover, in the liquid crystal display device 1, only the adhesive layer 16 and the phase plate 15 or the polarizing plate 17 are provided between the X electrodes 18 and the Y electrodes 19 which intersect with the X electrodes 18. This makes it possible to reduce a thickness of the liquid crystal display device 1 that has a touch panel function.

The liquid crystal display device 1 is manufactured by a method including (i) a step of providing X electrodes 18 or Y electrodes 19 on a phase plate 15 or on a polarizing plate 17 and (ii) a step of stacking the phase plate 15 or the polarizing plate 17, on which the X electrodes 18 or the Y electrodes 19 has been provided, on the liquid crystal panel 10 directly or via a member.

The liquid crystal display device 1 is thus manufactured, and it is therefore possible to provide the liquid crystal display device 1 which has (i) a reduced thickness and (ii) improved display quality.

The X electrode 18 or the Y electrode 19 is provided on the phase plate 15 or the polarizing plate 17 by a printing process.

As such, the X electrode 18 or the Y electrode 19 is formed on the phase plate 15 or on the polarizing plate 17 by the printing process that can be carried out at a low temperature. This prevents adverse effects on the phase plate 15 or the polarizing plate 17 which is easily affected by heat.

### Embodiment 2

The following description will discuss a display device in accordance with another embodiment of the present invention, with reference to FIGS. 4, 5, and 10. In Embodiment 2, an example is described in which an organic EL display device is employed as the display device. In the organic EL display device, a circularly polarizing plate made up of a polarizing plate and a λ/4 plate (quarter wave plate) is attached to an upper surface of an organic EL panel for preventing reflection light.

FIG. 10 is a cross sectional view illustrating a configuration of an organic EL panel 51. The organic EL panel 51 includes a glass substrate 51a, TFTs 51b, organic EL layers 51c, an adhesion layer 51d, and a sealing substrate 51e. The TFTs 51b are provided for respective pixels and serve as switching elements. The organic EL layers 51c are provided for the respective pixels. The adhesion layer 51d is provided so as to cover the organic EL layers 51c. The sealing substrate 51e is made up of a substrate such as a glass substrate and is stacked on the adhesion layer 51d (see FIG. 10).

FIG. 4 is a cross sectional view illustrating a configuration of the organic EL display device in accordance with Embodiment 2.

In an organic EL display device 50, a touch panel and a display device are integrated (see FIG. 4), unlike a conventional configuration in which a touch panel is stacked on a display device.

Specifically, a λ/4 plate 53 is attached to an upper surface of the organic EL panel 51 via an adhesive layer 52.

An X electrode 57 is provided on one surface of the λ/4 plate 53 which one surface faces the organic EL panel 51. A polarizing plate 55 is attached to the other surface of the λ/4 plate 53 via an adhesive layer 54.

A Y electrode 58 is provided on one surface of the polarizing plate 55 which one surface faces the λ/4 plate 53.

That is, the X electrode 57 and the Y electrode 58 are provided on the λ/4 plate 53 and the polarizing plate 55, respectively, so that a touched location will be detected as two-dimensional coordinates with an X-axis and a Y-axis.

According to the configuration, it is not necessary to additionally provide a base material in the organic EL display device 50 for providing the X electrode 57 and the Y electrode 58. This makes it possible to reduce a thickness of the entire organic EL display device 50 and to improve visibility.

The X electrode 57 and the Y electrode 58 may be provided on only one of the λ/4 plate 53 and the polarizing plate 55.

That is, it is possible to employ a configuration in which (i) one of the X electrode 57 and the Y electrode 58 is provided on the one surface of the λ/4 plate 53 and (ii) the other of the X electrode 57 and the Y electrode 58 is provided on the other surface of the λ/4 plate 53.

Alternatively, it is possible to employ a configuration in which (i) one of the X electrode 57 and the Y electrode 58 is provided on the one surface of the polarizing plate 55 and (ii) the other of the X electrode 57 and the Y electrode 58 is provided on the other surface of the polarizing plate 55.

Each of the λ/4 plate 53 and the polarizing plate 55 can be made of a generally used material.

It is preferable that the X electrode 57 and the Y electrode 58 (i) are made of a material such as transparent conductive ink which has been prepared by dispersing silver particles (nanowires) in a solution and (ii) are formed on the λ/4 plate 53 and the polarizing plate 55, respectively, by a printing process that can be carried out at a low temperature.

According to the configuration, a transparent conductive material is used as the material of the X electrode 57 and the Y electrode 58. This prevents an adverse effect on visibility.

Moreover, according to the configuration, the X electrode 57 and the Y electrode 58 are formed on the phase plate 53 and the polarizing plate 55, respectively, by the printing process that can be carried out (i) at a low temperature and (ii) without a high temperature treatment. This prevents adverse effects on the λ/4 plate 53 and the polarizing plate 55 which are easily affected by heat.

Note that examples of the printing process encompass screen printing, ink-jet printing, and offset printing. Other than the ink in which silver particles (nanowires) are dispersed, a carbon nanotube (CNT) dispersed liquid having high transmittance can be used as a transparent electrode material, of which the X electrode 18 and the Y electrode 19 are made.

It is preferable to use a transparent adhesive agent as a material of the adhesive layers 52 and 54. According to the configuration, visibility is not adversely affected.

In the organic EL display device 50, a cover glass 56 is provided so as to improve rigidity of the organic EL display device 50 and to protect the organic EL display device 50. The cover glass 56 can be made of a material such as a transparent glass or plastic.

The organic EL display device 50 of Embodiment 2 includes the cover glass 56. Note, however, that Embodiment 2 is not limited to this, and the cover glass 56 may be provided as appropriate.

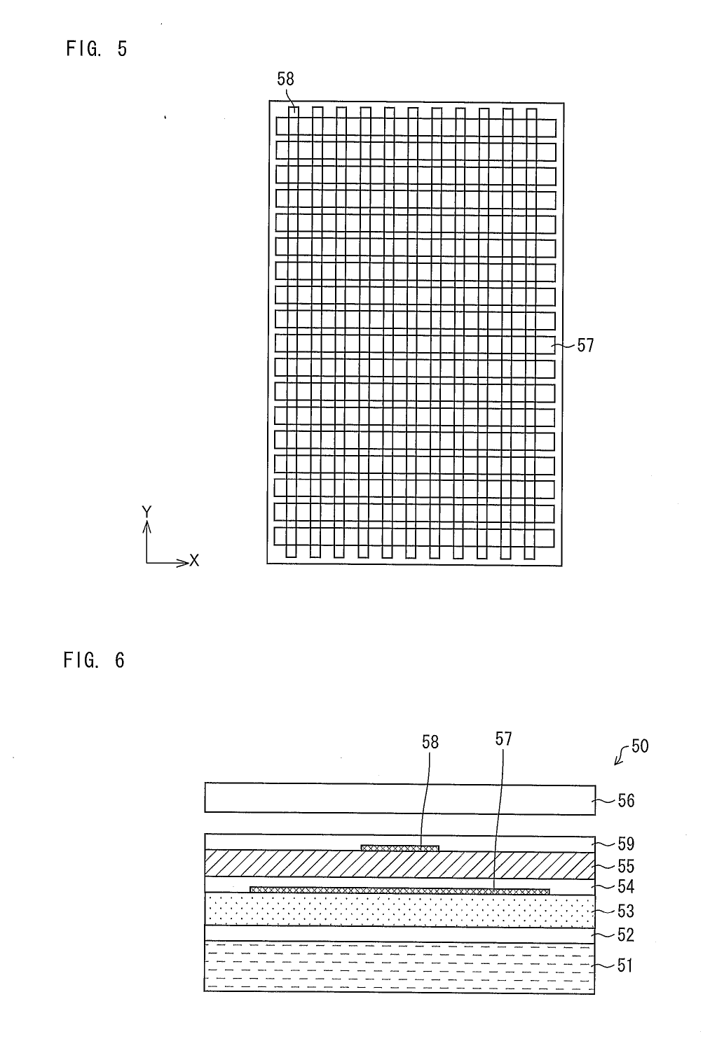

The following description will discuss how the X electrodes 57 and the Y electrodes 58 are arranged, with reference to FIG. 5.

FIG. 5 is a plane view illustrating how the X electrodes and the Y electrodes are arranged in the organic EL display device in accordance with Embodiment 2.

As illustrated in FIG. 5, a plurality of X electrodes 57, each of which has a belt-like shape, are arranged in parallel with each other, and a plurality of Y electrodes 58, each of which has a belt-like shape, are arranged in parallel with each other so as to perpendicularly intersect with the plurality of X electrodes 57, in order that two-dimensional coordinates can be expressed with the X-axis and the Y-axis. In a case where a fingertip (electric conductor) makes contact with a touch input surface, capacitance at intersections of the plurality of X electrodes 57 and the plurality of Y electrodes 58 is changed. This allows the organic EL display device 50 to detect two-dimensional coordinates of a location touched by the fingertip.

In Embodiment 2, the X electrode 57 is provided on the one surface of the λ/4 plate 53 which one surface faces the organic EL panel 51, and the Y electrode 58 is provided on the one surface of the polarizing plate 55 which one surface faces the organic EL panel 51. Note, however, that Embodiment 2 is not limited to this, and the X electrode 57 and the Y electrode 58 can be provided as appropriate on the λ/4 plate or the polarizing plate so that the X electrode 57 and the Y electrode 58 are located in different layers. The following description will discuss Modified Example 2.

### Modified Example 2

The following description will discuss a modified example of the organic EL display device of Embodiment 2, with reference to FIG. 6. FIG. 6 is a cross sectional view illustrating a configuration of an organic EL display device in accordance with Modified Example 2.

Note that, for convenience, the same reference numerals are given to constituent members which have functions identical with those of constituent members described in Embodiment 2.

In Modified Example 2, locations of the X electrode 57 and the Y electrode 58 are different from those in Embodiment 1.

Specifically, in Modified Example 2, the X electrode 57 is provided on a surface of the λ/4 plate 53 which surface faces the polarizing plate 55, and the Y electrode 58 is provided on a surface of the polarizing plate 55 which surface faces the cover glass 56, unlike Embodiment 2 in which the X electrode 57 is provided on a surface of the λ/4 plate 53 which surface faces the organic EL panel 51, and the Y electrode 58 is provided on a surface of the polarizing plate 55 which surface faces the organic EL panel 51. Note that an adhesive layer 59 is provided so as to cover the polarizing plate 55 and the Y electrode 58.

According to the configuration, it is not necessary to additionally provide a base material in the organic EL display device 50 for providing the X electrode 57 and the Y electrode 58, as with Embodiment 2. This makes it possible to reduce a thickness of the entire organic EL display device 50 and to improve visibility.

As such, in the organic EL display device 50, the λ/4 plate 53 or the polarizing plate 55 is provided between the X electrodes 57 and the Y electrodes 58 which intersect with the X electrodes 57. This allows the X electrodes 57 and the Y electrodes 58 to serve as electrodes for detecting a touched location.

Moreover, in the organic EL display device 50, only the adhesive layer 54 and the λ/4 plate 53 or the polarizing plate 55 are provided between the X electrodes 57 and the Y electrodes 58 which intersect with the X electrodes 57. This makes it possible to reduce a thickness of the organic EL display device 50 that has a touch panel function.

The organic EL display device 50 is manufactured by a method including (i) a step of providing an X electrode 57 or a Y electrode 58 on a λ/4 plate 53 or a polarizing plate 55 and (ii) a step of stacking the λ/4 plate 53 or the polarizing plate 55, on which the X electrode 57 or the Y electrode 58 has been provided, on the organic EL panel 51 directly or via a member.

The organic EL display device 50 is thus manufactured, and it is therefore possible to provide the organic EL display device 50 which has (i) a reduced thickness and (ii) improved display quality.

The X electrode 57 or the Y electrode 58 is provided on the λ/4 plate 53 or the polarizing plate 55 by a printing process.

As such, the X electrode 57 or the Y electrode 58 is formed on the λ/4 plate 53 or the polarizing plate 55 by the printing process that can be carried out at a low temperature. This prevents adverse effects on the λ/4 plate 53 or the polarizing plate 55 which is easily affected by heat.

The present invention is not limited to the embodiments, but can be altered by a skilled person in the art within the scope of the claims. An embodiment derived from a proper combination of technical means disclosed in respective different embodiments is also encompassed in the technical scope of the present invention.

As above described, the display device of the present invention includes: a plurality of input detection electrodes, which are provided in a display area, for detecting an input on a display surface; a display panel; and a plurality of optical plate members that are stacked on the display panel and contribute to a display or to improvement in display quality, at least one of the plurality of input detection electrodes being provided on at least one of the plurality of optical plate members.

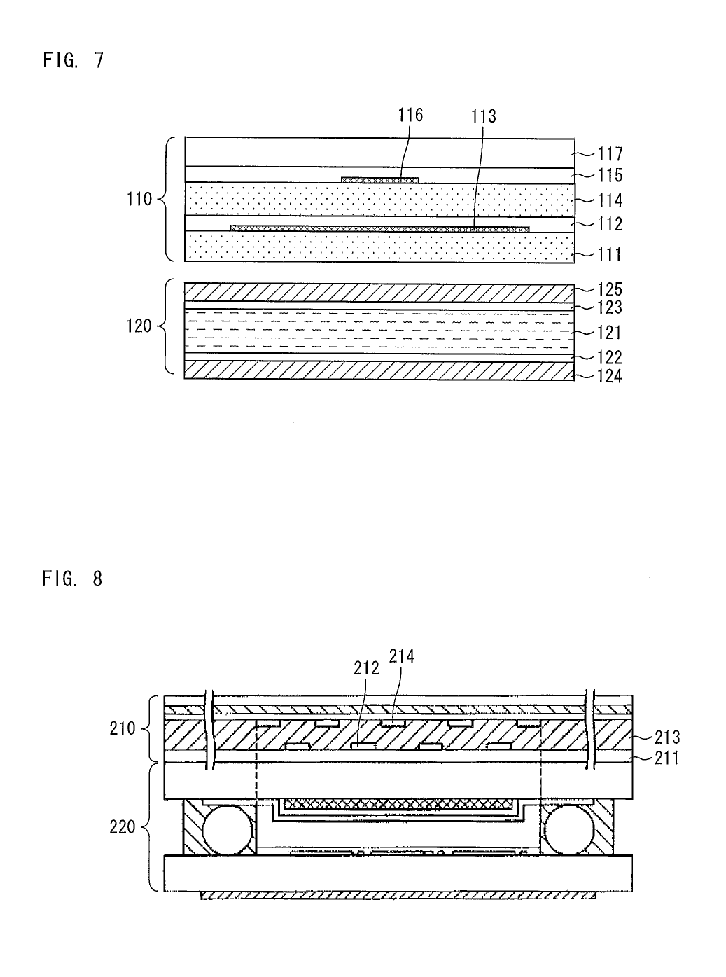

According to the conventional configuration as early described with reference to FIG. 7, the input detection electrodes for detecting an input on the display surface are provided on a base material which is provided separately from the display device.

On the other hand, according to the configuration of the present invention, at least one of the plurality of input detection electrodes is provided on at least one of the plurality of optical plate members that contribute to a display or to improvement in display quality. In other words, the input detection electrode is provided on a member that is required in view of a display function.

According to the configuration of the present invention, it is therefore possible to omit a superfluous base material. Consequently, it is possible to reduce a thickness of the display device.

According to the configuration of the present invention, at least one of the plurality of input detection electrodes is provided on at least one of the plurality of optical plate members. This configuration is fundamentally different from the conventional configuration illustrated in FIG. 8 in which the input detection electrodes are provided on both sides of the liquid crystal layer. Therefore, in the configuration of the present invention, it is possible to prevent (i) an irregular color caused due to level (height) difference between electrodes and (ii) uneven orientation caused due to an electric field.

As such, the configuration of the present invention brings about an effect of improving display quality while reducing the thickness of the display device.

Note that the term “plate member” encompasses a wafer-thin member that is generally called a sheet or a film.

Examples of the optical plate member that contributes to a display encompass a phase plate and a polarizing plate that are provided in a case where the display panel is a liquid crystal display panel. In the liquid crystal display panel, a display is carried out by a combination of a liquid crystal layer, the phase plate, and the polarizing plate.

Examples of the optical plate member that contributes to improvement in display quality encompass a polarizing plate and a quarter wave plate that are provided in a case where the display panel is an electroluminescence display panel. The polarizing plate and the quarter wave plate contribute to improvement in display quality by preventing or suppressing reflection of light.

Note that the optical plate member that contributes to a display or to improvement in display quality may be a film, other than above exemplified, such as a glare-proof film (anti-glare (AG) film), a viewing angle improving film (wide view (WV) film), or a luminance improving film.

In order to attain the object, in the display device of the present invention, it is preferable that the display panel is a liquid crystal display panel; the plurality of optical plate members are a phase plate and a polarizing plate; and the plurality of input detection electrodes are provided on the phase plate and the polarizing plate, respectively.

According to the configuration, it is not necessary to additionally provide a base material in the liquid crystal display device for providing the plurality of input detection electrodes. This makes it possible to reduce a thickness of the entire liquid crystal display device and to improve visibility.

In order to attain the object, in the display device of the present invention, it is preferable that the display panel is an electroluminescence display panel; the plurality of optical plate members are a polarizing plate and a quarter wave plate; and the plurality of input detection electrodes are provided on the polarizing plate and the quarter wave plate, respectively.

According to the configuration, it is not necessary to additionally provide a base material in the electroluminescence display device for providing the plurality of input detection electrodes. This makes it possible to reduce a thickness of the entire electroluminescence display device and to improve visibility.

It is possible to employ a configuration in which the plurality of input detection electrodes include a plurality of X electrodes and a plurality of Y electrodes, the plurality of X electrodes being arranged in parallel with each other, and the plurality of Y electrodes being arranged in parallel with each other in a direction perpendicular to the plurality of X electrodes; the plurality of X electrodes are provided on one of the phase plate and the polarizing plate; and the plurality of Y electrodes are provided on the other one of the phase plate and of the polarizing plate.

According to the configuration, it is not necessary to additionally provide a base material for providing the X electrodes and the Y electrodes that are used to detect a touched location. This makes it possible to reduce an entire thickness and to improve visibility.

It is possible to employ a configuration in which the plurality of input detection electrodes include a plurality of X electrodes and a plurality of Y electrodes, the plurality of X electrodes being arranged in parallel with each other, and the plurality of Y electrodes being arranged in parallel with each other in a direction perpendicular to the plurality of X electrodes; the plurality of X electrodes are provided on one of the polarizing plate and the quarter wave plate; and the plurality of Y electrodes are provided on the other one of the polarizing plate and the quarter wave plate.

According to the configuration, it is not necessary to additionally provide a base material for providing the X electrodes and the Y electrodes that are used to detect a touched location. This makes it possible to reduce an entire thickness and to improve visibility.

The present invention can be expressed as follows:

A display device including: a plurality of input detection electrodes, which are provided in a display area, for detecting an input on a display surface; a display panel; and a plurality of optical plate members that are stacked on the display panel and contribute to a display or to improvement in display quality, at least one of the plurality of input detection electrodes being provided on at least one of the plurality of optical plate members.

The display device, wherein: the display panel is a liquid crystal display panel; the plurality of optical plate members are a phase plate and a polarizing plate; and at least one of the plurality of input detection electrodes is provided on at least one of the phase plate and the polarizing plate.

The display device, wherein: the display panel is an electroluminescence display panel; the plurality of optical plate members are a polarizing plate and a quarter wave plate; and at least one of the plurality of input detection electrodes is provided on at least one of the polarizing plate and the quarter wave plate.

The display device, wherein: the plurality of input detection electrodes include a plurality of X electrodes and a plurality of Y electrodes, the plurality of X electrodes extending in one direction and being arranged in parallel with each other, and the plurality of Y electrodes extending in a direction perpendicular to the one direction and being arranged in parallel with each other; the plurality of X electrodes are provided on a surface of one of the phase plate and the polarizing plate; and the plurality of Y electrodes are provided on a surface of the other of the phase plate and the polarizing plate.

The display device, wherein: the plurality of input detection electrodes include a plurality of X electrodes and a plurality of Y electrodes, the plurality of X electrodes extending in one direction and being arranged in parallel with each other, and the plurality of Y electrodes extending in a direction perpendicular to the one direction and being arranged in parallel with each other; the plurality of X electrodes are provided on a surface of one of the polarizing plate and the quarter wave plate; and the plurality of Y electrodes are provided on a surface of the other of the polarizing plate and the quarter wave plate.

The display device, wherein: any of a phase plate, a polarizing plate, and a quarter wave plate is provided between (i) the plurality of X electrodes and (ii) the plurality of Y electrodes which intersect with the plurality of X electrodes.

The display device, wherein: only an adhesive agent and any of the phase plate, the polarizing plate, and the quarter wave plate are provided between (i) the plurality of X electrodes and (ii) the plurality of Y electrodes which intersect with the plurality of X electrodes.

A method for manufacturing a display device including a plurality of input detection electrodes, which are provided in a display area, for detecting an input on a display surface, the method including the steps of: providing at least one of the plurality of input detection electrodes on an optical plate member that contributes to a display or to improvement in display quality; and stacking the optical plate member, on which the at least one of the plurality of input detection electrodes has been provided, on a display panel.

The method for manufacturing the display device, wherein: the optical plate member is a phase plate, a polarizing plate, or a quarter wave plate; and at least one of the plurality of input detection electrodes is provided on the phase plate, the polarizing plate, or the quarter wave plate by a printing process.

### INDUSTRIAL APPLICABILITY

The present invention is suitably applicable to an electronic apparatus as a display device having a touch function.

### REFERENCE SIGNS LIST

1: Liquid crystal display device

10: Liquid crystal panel

11, 14, 16, 21: Adhesive layer

12, 15: Phase plate (optical plate member)

13, 17: Polarizing plate (optical plate member)

18: X electrode (input detection electrode)

19: Y electrode (input detection electrode)

20: Cover glass

50: Organic EL display device

51: Organic EL panel

52, 54, 59: Adhesive layer

53: λ/4 plate (optical plate member)

55: Polarizing plate (optical plate member)

56: Cover glass

57: X electrode (Input detection electrode)

58: Y electrode (Input detection electrode)

1-9. (canceled)

10. A display device comprising:
a plurality of input detection electrodes, which are provided in a display area, for detecting an input on a display surface;
a display panel; and
a plurality of optical plate members that are stacked on the display panel and contribute to a display or to improvement in display quality,
at least one of the plurality of input detection electrodes being provided on at least one of the plurality of optical plate members,
the display panel being a liquid crystal display panel,
the plurality of optical plate members being a phase plate and a polarizing plate,
at least one of the plurality of input detection electrodes being provided directly on at least one of the phase plate and the polarizing plate, and
each of the plurality of input detection electrodes being made of a transparent conductive material containing (i) silver particles or (ii) carbon nanotubes.

11. A display device comprising:
a plurality of input detection electrodes, which are provided in a display area, for detecting an input on a display surface;
a display panel; and
a plurality of optical plate members that are stacked on the display panel and contribute to a display or to improvement in display quality,
at least one of the plurality of input detection electrodes being provided on at least one of the plurality of optical plate members,
the display panel being an electroluminescence display panel,
the plurality of optical plate members being a polarizing plate and a quarter wave plate,
at least one of the plurality of input detection electrodes being provided directly on at least one of the polarizing plate and the quarter wave plate, and
each of the plurality of input detection electrodes being made of a transparent conductive material containing (i) silver particles or (ii) carbon nanotubes.

12. The display device as set forth in claim 10, wherein:
the plurality of input detection electrodes include a plurality of X electrodes and a plurality of Y electrodes, the plurality of X electrodes extending in one direction and being arranged in parallel with each other, and the plurality of Y electrodes extending in a direction perpendicular to the one direction and being arranged in parallel with each other;
the plurality of X electrodes are provided on a surface of one of the phase plate and the polarizing plate; and
the plurality of Y electrodes are provided on a surface of the other of the phase plate and the polarizing plate.

13. The display device as set forth in claim 11, wherein:
the plurality of input detection electrodes include a plurality of X electrodes and a plurality of Y electrodes, the plurality of X electrodes extending in one direction and being arranged in parallel with each other, and the plurality of Y electrodes extending in a direction perpendicular to the one direction and being arranged in parallel with each other;
the plurality of X electrodes are provided on a surface of one of the polarizing plate and the quarter wave plate; and
the plurality of Y electrodes are provided on a surface of the other of the polarizing plate and the quarter wave plate.

14. The display device as set forth in claim 12, wherein:
the phase plate, or the_polarizing plate is provided between (i) the plurality of X electrodes and (ii) the plurality of Y electrodes which intersect with the plurality of X electrodes.

15. The display device as set forth in claim 14, wherein:
only an adhesive agent and the phase plate or the polarizing plate are provided between (i) the plurality of X electrodes and (ii) the plurality of Y electrodes which intersect with the plurality of X electrodes.

16. A method for manufacturing a display device including a plurality of input detection electrodes, which are provided in a display area, for detecting an input on a display surface, said method comprising the steps of:
providing at least one of the plurality of input detection electrodes directly on an optical plate member by a printing process, the optical plate member (i) contributing to a display or to improvement in display quality and (ii) being a phase plate, a polarizing plate, or a quarter wave plate; and
stacking the optical plate member, on which the at least one of the plurality of input detection electrodes has been provided, on a display panel.
